(19) United States
(12) Patent Application Publication
(10) Pub. No.: US 2025/0341737 A1
(43) Pub. Date: Nov. 6, 2025

(54) Thermo-optic switch control

(71) Applicant: Lyte AI, Inc., Mountain View, CA (US)

(72) Inventors: Arman Hajati, San Carlos, CA (US); Mark Lemkin, Berkeley, CA (US); Yangjin Ma, Bellevue, WA (US)

(21) Appl. No.: 19/218,278

(22) Filed: May 25, 2025

Related U.S. Application Data
(63) Continuation-in-part of application No. 18/864,557, filed on Nov. 11, 2024.
(60) Provisional application No. 63/342,176, filed on May 16, 2022.

(51) Int. Cl. G02F 1/01; G02F 1/21; G02F 1/225

(52) U.S. Cl. CPC G02F 1/0147; G02F 1/212; G02F 1/225

(57) ABSTRACT

A thermo-optic device, including a waveguide having a respective input end and output end, and including a heater configured to heat the waveguide. The thermo-optic device includes a digital controller, configured to generate a digital control signal selected to induce a target phase shift in an optical signal propagating through the waveguide, and includes a digital-to-analog converter (DAC) coupled to convert the digital control signal to an analog signal for application to the heater.

### CROSS-REFERENCE TO RELATED APPLICATIONS

This application is a Continuation-in-Part Application of U.S. patent application Ser. No. 18/864,557, filed on Nov. 11, 2024, which is a National Stage Entry of PCT International Application No. PCT/US2023/066982, filed on May 15, 2023, which claims the benefit of U.S. Provisional Patent Application 63/342,176, filed May 16, 2022, each of which is incorporated herein by reference in its entirety.

### FIELD OF THE INVENTION

The present invention relates generally to thermo-optic switches and control systems.

### BACKGROUND

A thermo-optic switch operates based on the thermo-optic effect whereby the refractive index of a material changes with temperature. Thermal modulations in the refractive index are utilized to realize switching functionality, such as by using temperature changes to control transmission of light in optical waveguides. A thermo-optic switch includes a microheater, such as a resistive element, and an optical waveguide. Application of heat by the microheater induces temperature changes in the waveguide leading to changes in the refractive index profile which affects light propagation. This can be exploited to switch light between different paths in an optical circuit. One type of thermo-optic switch employs a Mach-Zehnder Interferometer (MZI) having a pair of waveguides with respective heaters to control interference for directing an optical signal to a selected output. Different materials, such as silicon, silica, and silicon nitride, experience changes in refractive index upon heating and may be used for fabricating thermo-optic switches. Polymer devices may be particularly suitable for digital switching due to their high thermo-optic coefficient and low thermal conductivity providing efficient power conversion. Thermo-optic switches may be employed in a variety of applications, ranging from optical fiber communication networks; photonic integrated circuits (PICs); light detection and ranging (LIDAR); wavelength division multiplexing (WDM) systems; and optical signal routing in data centers.

### SUMMARY

Embodiments of the present invention that are described hereinbelow provide improved systems, devices, and methods for thermo-optic phase shifting and switching.

There is therefore provided, in accordance with an embodiment of the invention, a thermo-optic device, including a waveguide having a respective input end and output end, and including a heater configured to heat the waveguide. The thermo-optic device includes a digital controller, configured to generate a digital control signal selected to induce a target phase shift in an optical signal propagating through the waveguide, and includes a digital-to-analog converter (DAC) coupled to convert the digital control signal to an analog signal for application to the heater.

In a disclosed embodiment, the digital controller is configured to update a numerical discrete-time model of the heater and the waveguide, and to generate the digital control signal responsive to the model. In some embodiments, the numerical discrete-time model is configured to compute a model temperature of the waveguide, and the digital controller is configured to generate the digital control signal responsively to a difference between a setpoint temperature corresponding to the target phase shift and the model temperature. In some embodiments, the digital controller includes a proportional-integral-derivative (PID) controller, which is configured to receive the difference between the setpoint temperature and the model temperature as an input and to output the digital control signal.

In a disclosed embodiment, the digital controller is configured to drive the heater with a voltage, corresponding to the analog waveform, the voltage including a pre-emphasis pulse. In some embodiments, the digital controller is configured to update the numerical discrete-time model using a calibration process. In some embodiments, the numerical discrete-time model includes a nonlinear modelling of at least one physical nonlinearity of a portion of the device. In some embodiments, the DAC includes at least one component of: a delta-sigma modulator; a sigma-delta modulator; a switch; and/or an amplifier. In a disclosed embodiment, the digital controller is configured to apply an inverse nonlinearity of at least one physical nonlinearity of a portion of the device, to the digital control signal. Additionally or alternatively, the digital controller is configured to apply a saturation nonlinearity before the digital control signal is generated, the saturation nonlinearity modeling a finite range of the DAC.

There is also provided, in accordance with an embodiment of the invention, a thermo-optic switch, including an interferometer including first and second waveguides having respective input ends and output ends, and including at least one heater configured to heat at least one of the first and second waveguides. The thermo-optic switch includes a splitter coupled to receive a coherent optical signal and to input the optical signal to the input ends of both the first and second waveguides. The thermo-optic switch includes a mixer, for example a multi-mode interferometer (MMI), coupled to receive and mix the optical signal from the output ends of the first and second waveguides and to direct the mixed optical signal to a first output or a second output of the switch depending on a phase shift between the first and second waveguides. The thermo-optic switch includes a digital controller, configured to generate at least one digital control signal selected to induce a target phase shift in the optical signal propagating through the at least one of the first and second waveguides. The thermo-optic switch includes at least one digital-to-analog converter (DAC) coupled to convert the at least one digital control signal to at least one analog waveform for application to the at least one heater.

In a disclosed embodiment, the heater includes first and second heaters coupled respectively to heat the first and second waveguides, the digital controller is configured to generate first and second digital control signals, and the DAC includes first and second DACs coupled to convert the first and second digital control signals to first and second analog waveforms for application to the first and second heaters, respectively. In some embodiments, the digital controller is configured to drive the first heater and the second heater in alternation, to toggle the mixed optical signal between the first output and the second output of the switch. In some embodiments, the digital controller is configured to drive the first heater and the second heater with a voltage, corresponding to the analog waveform, the voltage including a pre-emphasis pulse when the mixed optical signal is toggled.

In a disclosed embodiment, the digital controller is configured to update a numerical discrete-time model of the heater and at least one of the first and second waveguides, and to generate the digital control signal responsive to the model. In some embodiments, the numerical discrete-time model is configured to compute a model temperature of the waveguide, and the digital controller is configured to generate the digital control signal responsively to a difference between a setpoint temperature corresponding to the target phase shift and the model temperature. In some embodiments, the digital controller includes a proportional-integral-derivative (PID) controller, which is configured to receive the difference between the setpoint temperature and the model temperature as an input and to output the digital control signal.

In some embodiments, the digital controller is configured to update the numerical discrete-time model using a calibration process. In some embodiments, the numerical discrete-time model includes a nonlinear modelling of at least one physical nonlinearity of a portion of the device. In a disclosed embodiment, the digital controller is configured to apply an inverse nonlinearity of at least one physical nonlinearity of a portion of the device, to the digital control signal. Additionally or alternatively, the digital controller is configured to apply a saturation nonlinearity before the digital control signal is generated, the saturation nonlinearity modeling a finite range of the DAC. In some embodiments, the DAC includes at least one component of: a delta-sigma modulator; a sigma-delta modulator; a switch; and/or an amplifier.

There is additionally provided, in accordance with an embodiment of the invention, a method for thermo-optic switching. The method includes generating, by a digital controller, a digital control signal selected to induce a target phase difference between a first waveguide and a second waveguide of a thermo-optic switch. The method includes converting, by a digital-to-analog converter (DAC), the digital control signal to at least one analog waveform for application to at least one heater in the thermo-optic switch, for heating at least one of the first waveguide and the second waveguide. An optical signal from the output ends of the first waveguide and the second waveguide is switched between a first output or a second output of the switch, depending on the target phase difference.

In a disclosed embodiment, generating the digital control signal includes generating first and second digital control signals corresponding to first and second analog waveforms for application to heat the first waveguide and the second waveguide in alternation, to toggle the optical signal between the first output and the second output of the switch. In some embodiments, generating the digital control signal comprises applying a pre-emphasis pulse to drive the heater.

In a disclosed embodiment, generating the digital control signal includes generating and updating a numerical discrete-time model of the heater and the waveguide, and generating the digital control signal responsive to the model. In some embodiments, generating the digital control signal includes computing, by the numerical discrete-time model, a model temperature of the waveguide, and generating the digital control signal responsively to a difference between a setpoint temperature corresponding to the target phase shift and the model temperature. In some embodiments, generating the digital control signal includes receiving, by a proportional-integral-derivative (PID) controller of the digital controller, the difference between the setpoint temperature and the model temperature as an input, and outputting the digital control signal by the PID controller.

In a disclosed embodiment, the method includes updating the numerical discrete-time model using a calibration process. In a disclosed embodiment, the method includes a nonlinear modelling of at least one physical nonlinearity of a portion of the device. In some embodiments, the method includes applying an inverse nonlinearity of at least one physical nonlinearity of a portion of the device, to the digital control signal. Additionally or alternatively, the method includes applying a saturation nonlinearity of the DAC, before generating the digital control signal.

There is further provided, in accordance with an embodiment of the invention, a method for controlling a thermo-optic device. The method includes generating, by a digital controller, a digital control signal selected to induce a target phase shift in an optical signal propagating through a waveguide by heating the waveguide. The method includes converting, by a digital-to-analog converter (DAC), the digital control signal to an analog waveform for application to a heater of the waveguide.

In a disclosed embodiment, generating the digital control signal includes updating a numerical discrete-time model of the heater and the waveguide, and generating the digital control signal responsive to the model. In some embodiments, generating the digital control signal includes computing, by the numerical discrete-time model, a model temperature of the waveguide, and generating the digital control signal responsively to a difference between a setpoint temperature corresponding to the target phase shift and the model temperature. In some embodiments, generating the digital control signal includes receiving, by a proportional-integral-derivative (PID) controller of the digital controller, the difference between the setpoint temperature and the model temperature as an input, and outputting the digital control signal by the PID controller.

In a disclosed embodiment, the method includes driving the heater with a voltage including a pre-emphasis pulse, the voltage corresponding to the analog waveform. In some embodiments, the method includes updating the numerical discrete-time model using a calibration process. In some embodiments, the method includes a nonlinear modelling of at least one physical nonlinearity of a portion of the device. In some embodiments, the method includes applying an inverse nonlinearity of at least one physical nonlinearity of a portion of the device, to the digital control signal. Additionally or alternatively, the method includes applying a saturation nonlinearity of the DAC, before generating the digital control signal.

The present invention will be more fully understood from the following detailed description of the embodiments thereof, taken together with the drawings in which:

### BRIEF DESCRIPTION OF THE DRAWINGS

FIG. 1A is a block diagram that schematically illustrates an optical switching tree on a PIC, in accordance with an embodiment of the invention;

FIG. 1B shows two plots that schematically illustrate the response of a thermo-optic switch to voltages applied to resistive heaters of the switch, in accordance with an embodiment of the invention;

FIGS. 2A, 2B, and 2C show plots that schematically illustrate a voltage control scheme for a thermo-optic switch and a response of the switch to the applied voltages, in accordance with alternative embodiments of the invention;

FIG. 3A is a block diagram that schematically illustrates an optical switching tree on a PIC including a fast thermo-optic switch, in accordance with another embodiment of the invention;

FIG. 3B shows three plots that schematically illustrate a voltage control scheme for a thermo-optic switch and a response of the switch to the applied voltages, in accordance with another embodiment of the invention;

FIG. 4 is a block diagram that schematically illustrates an open-loop feedforward control system for controlling a thermo-optic switch, in accordance with an embodiment of the invention;

FIG. 5 is a schematic illustration of an exemplary model for implementing a numerical modelling of a thermo-optic switch control system, in accordance with an embodiment of the invention;

FIG. 6A is a block diagram that schematically illustrates a thermo-optic switch control system with a first exemplary nonlinearity compensation approach, in accordance with an embodiment of the invention; and

FIG. 6B is a block diagram that schematically illustrates a thermo-optic switch control system with a second exemplary nonlinearity compensation approach, in accordance with another embodiment of the invention.

### DETAILED DESCRIPTION OF EMBODIMENTS

### Overview

Thermo-optic switches may be utilized in photonic integrated circuits (PICs). For example, a PIC may include a hierarchical optical-switching network made up of thermo-optic switches serving as an optical-distribution tree. A plurality of switches may distribute output beams via waveguides for transmission by an array of transceiver cells. Network hierarchies may be defined with multiple tiers of switches, including certain switches having faster switching times relative to other switches in the network, as described in PCT International Publication WO 2023/225468. PIC technology may be used for producing photonic transceiver chips which may be incorporated in transceiver arrays and scanning systems, examples of which are described in PCT International Publications WO 2023/023106, WO 2023/023105, WO 2023/034465 and in PCT Patent Application PCT/US2022/47516. All the above PCT publications and applications are assigned to the assignee of the present patent application, and their disclosures are incorporated herein by reference.

### Fast Thermo-Optic Switching

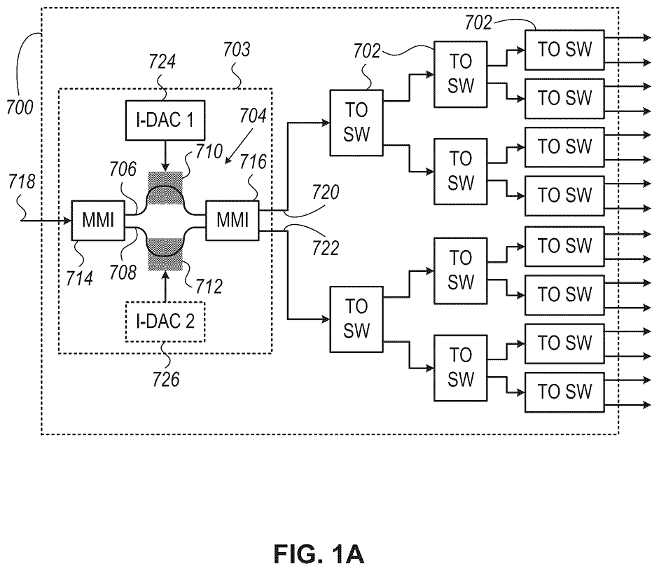

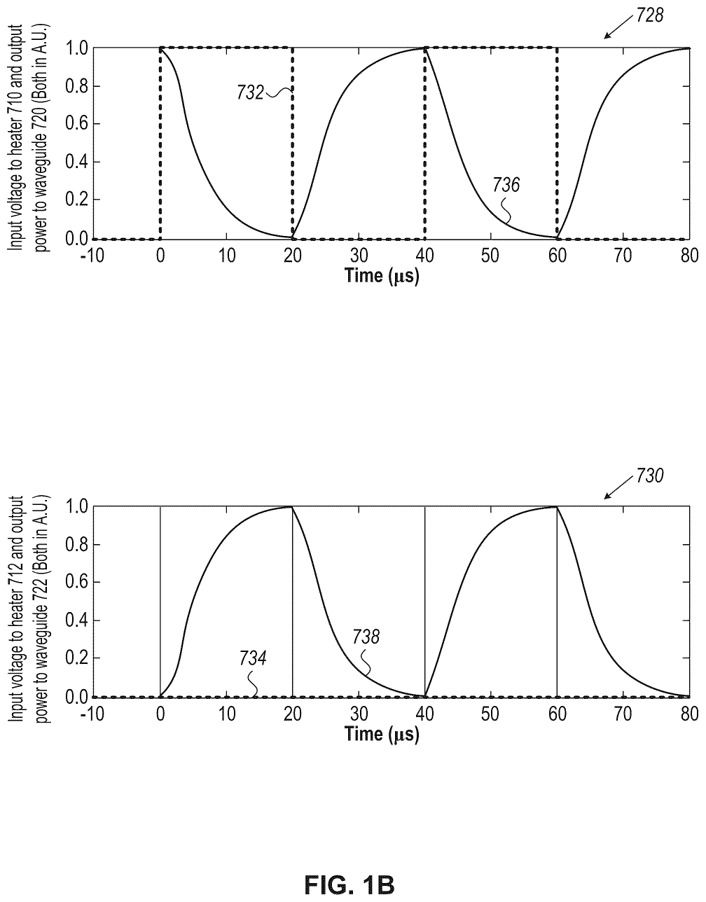

FIG. 1A is a block diagram that schematically illustrates an optical switching tree on a PIC 700, in accordance with an embodiment of the invention. PIC 700 uses thermo-optic switches 702 (labeled TO SW). A fast variant of switches 702, switch 703, is described hereinbelow in detail.

Switch 703 comprises a Mach-Zehnder interferometer (MZI) 704 comprising two branch waveguides 706 and 708, with resistive heaters 710 and 712 on respective branches. A multi-mode interference (MMI) cell 714 serves as a splitter, to split a coherent optical signal from an incoming waveguide 718 between the input ends of the two branch waveguides 706 and 708. Another MMI cell 716 serves as a mixer, to mix the optical signals from the output ends of waveguides 706 and 708 into one of two outgoing waveguides 720 or 722, depending on the optical phase difference between the branches. Digital controllers 724 and 726 set the voltage applied to the respective resistive heaters 710 and 712 to control the respective optical phase shifts in waveguides 706 and 708, respectively, and thus toggle the setting of the switch between the two outgoing waveguides 720 and 722. Controller 726 is shown in a dashed-line frame to signify that in some embodiments, a single controller with a switched output can be used to drive both heaters 710 and 712. Furthermore, in some embodiments only a single heater 710 or 712 is controlled to provide a control of phase sufficient to enable an input signal (from a branch waveguide 706, 708) to toggle between multiple outputs (outgoing waveguides 720 and 722). Controllers 724 and 726 may be advantageously implemented using digital to analog converters (DACs) to generate the waveforms for driving heaters 710 and 712, and are thus labeled I-DAC 1 and I-DAC 2, respectively. In various embodiments the I-DAC is a DAC having a voltage output; the I-DAC is a DAC having a current output; the I-DAC is a one-bit DAC; and/or the I-DAC is differential.

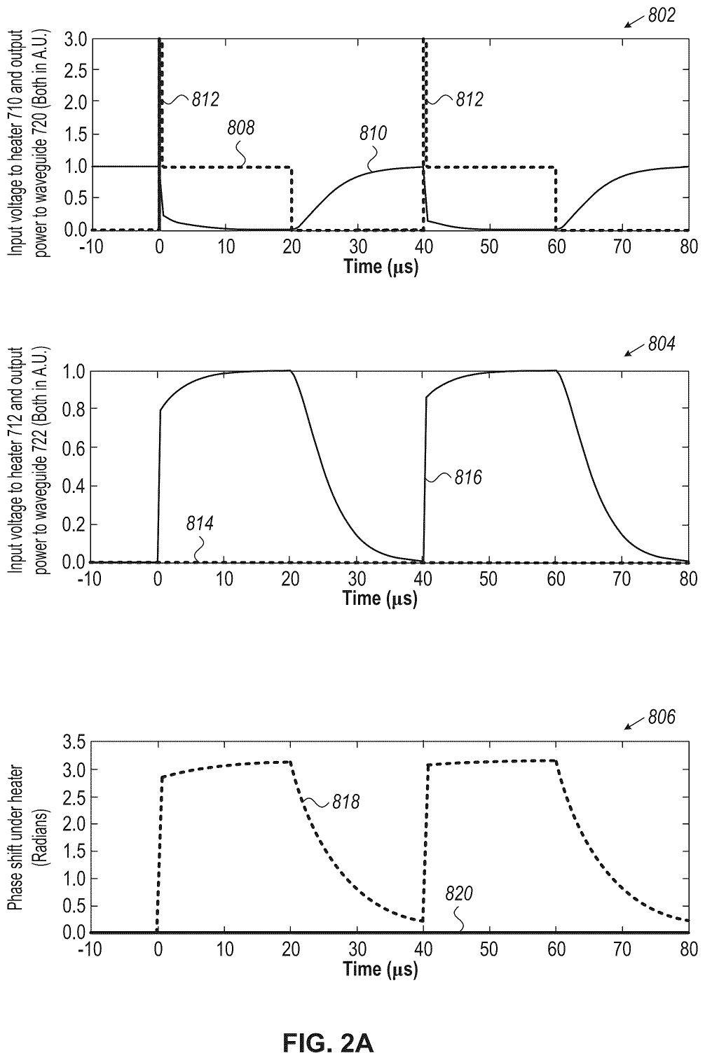

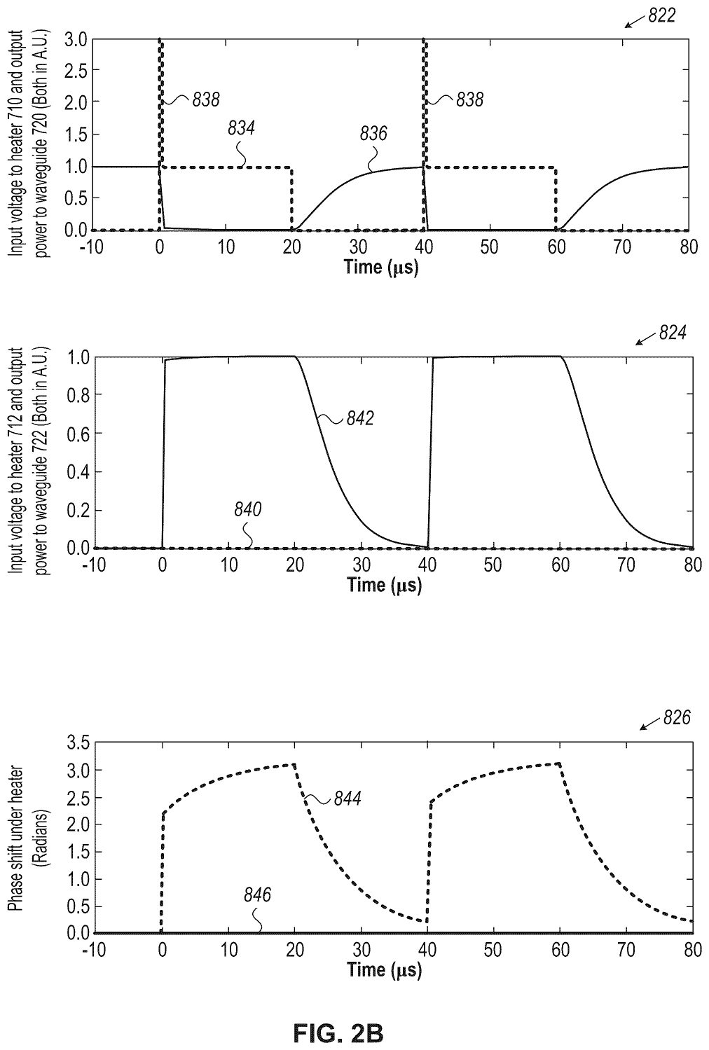

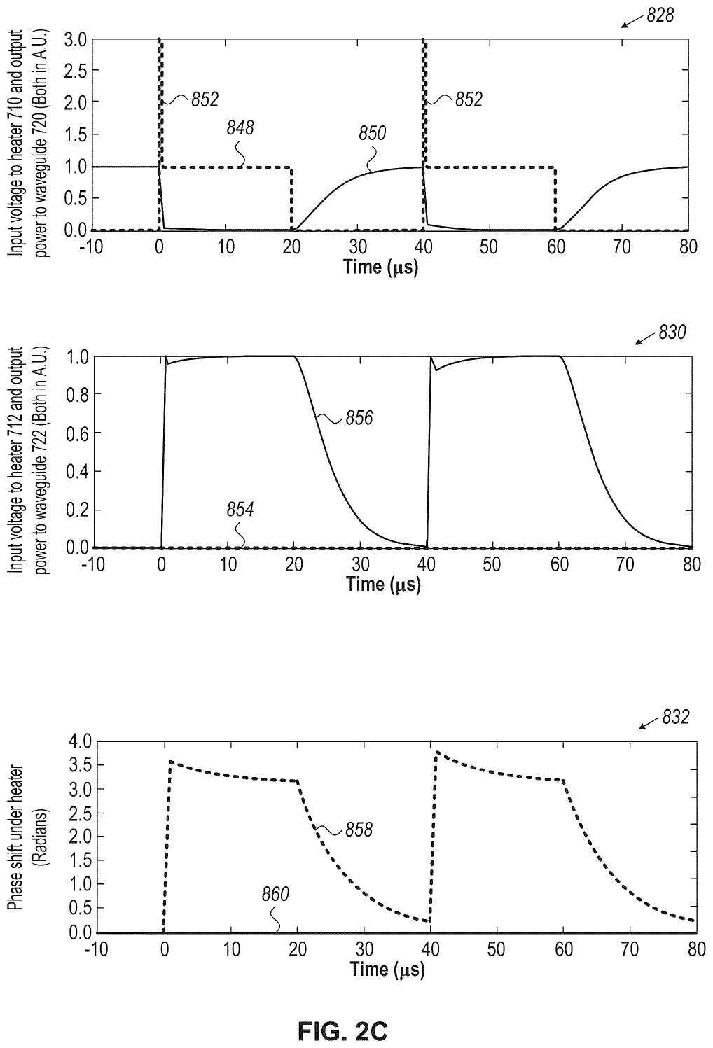

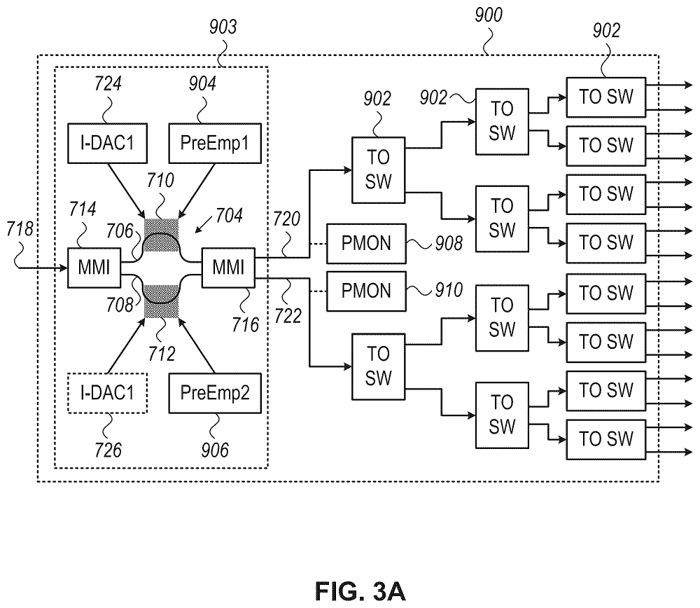

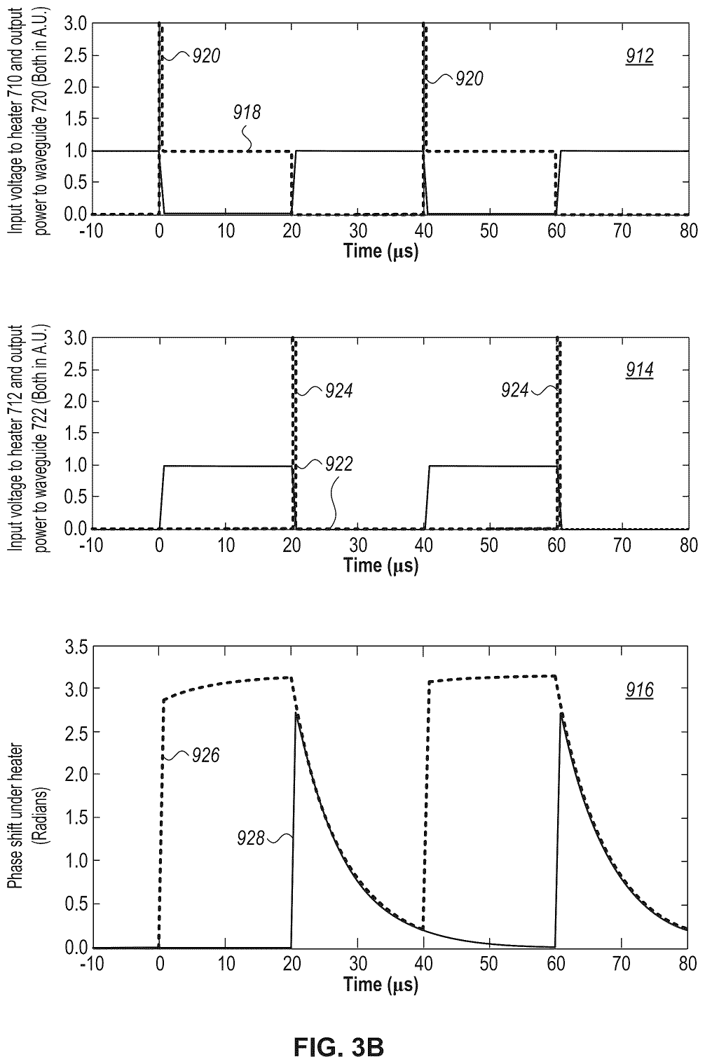

Switches 702 are similar to switch 703, but may use a simpler drive scheme in order to reduce the size and complexity of the circuits on PIC 700. Switch 703 implements a push-pull scheme, in which heaters 710 and 712 are driven in alternation, to provide faster switching than switch 702 and toggle the mixed optical signal between the outputs of switch 703. As will be detailed in FIGS. 2A-2C and 3A-3B, switch 703 may be sped up even more by using a pre-emphasis voltage pulse as part of the push-pull scheme each time the outputs are toggled.

As is shown in FIG. 1A, switch 703 is used only in the first tier of switches in PIC 700. Thus, the fast switch 703 is used judiciously only where it is needed, while switches 702 are used elsewhere in the switching tree of PIC 700. Although the pictured examples in FIG. 1A and in the figures hereinbelow show the enhanced switch 703 in only a single location in the first tier, in other embodiments similar fast thermo-optical switches may be deployed in other or all tiers, in addition to or instead of the first tier.

FIG. 1B shows plots 728 and 730, schematically illustrating the response of switch 703 to voltages applied to resistive heaters 710 and 712 in a basic implementation, in accordance with an embodiment of the invention. Plots 728 and 730 show curves of respective voltages 732 and 734 applied over time to respective resistive heaters 710 and 712 in switch 703 of FIG. 1A, as well as the output optical powers 736 and 738 in waveguides 720 and 722. (In the present embodiment voltage 734 is zero.) Application of a voltage to one of the two heaters (to heater 710 in FIG. 1B) causes the optical outputs to switch at a rate governed by open-loop dynamics associated with the thermo-optical switch. Likewise, when the voltage is removed from the heater the optical output switches at a rate governed by the same open-loop dynamics. The speed of switching of optical power between the two outgoing waveguides 720 and 722 is limited to the open-loop response by the same token. In this example, the switching time is about 10 μs.

FIGS. 2A, 2B, and 2C show plots schematically illustrating the response of switch 703 (FIG. 1A) to voltages applied over time to resistive heaters 710 and 712 in an implementation using a pre-emphasis voltage, in accordance with embodiments of the invention.

In these embodiments, a pre-emphasis voltage is applied for a short period of time when switch 703 is first turned on. A “pre-emphasis voltage” is defined herein as a voltage higher than a static voltage required to attain steady-state switching. The addition of a pre-emphasis voltage to one of the resistive heaters 710 or 712 for a short period reduces the turn-on time of switch 703 to about 1 μs in the present embodiment. Application of a step voltage to a heater 710, 712 may cause the switching temperature to respond according to the step-response of a characteristic equation representing the switch 703 (i.e., an open-loop step response). By applying a (higher) pre-emphasis voltage, the step-response of thermo-optic switch 703 more rapidly rises to the desired temperature. During this period, the temperature is still evolving at the same exponential rate, but the exponential characteristics are amplified by the ratio of the pre-emphasis voltage to steady state voltage. For the sake of comparison, three different durations of the pre-emphasis voltage pulses are shown in FIGS. 2A-2C. The turn-off time, however, is still limited by the rate of cooling, unless the second heater is also energized. In the present embodiment the pre-emphasis voltage is applied by I-DAC 1. Alternatively, a pre-emphasis voltage may be applied to either of heaters 710 or 712 by a controller parallel to I-DAC 1 or I-DAC 2, as will be shown in FIG. 3A hereinbelow.

FIG. 2A shows plots 802, 804, and 806. In plot 802, a curve 808 shows the input voltage to heater 710 and a curve 810 shows the power in waveguide 720, both in arbitrary units (A.U.). The pre-emphasis voltage comprises a sharp peak 812 at each rising edge of curve 808, with a peak amplitude of 3A.U. and a width of 0.6 μs. In plot 804, a curve 814 shows the input voltage to heater 712 (zero in the present embodiment) and a curve 816 shows the optical power in waveguide 722. A comparison of curve 816 to curve 738 in FIG. 1B shows that the turn-on time demonstrated in curve 816 is faster than that in curve 738. In plot 806, curves 818 and 820 show the optical phase shifts under respective resistive heaters 710 and 712.

FIG. 2B shows plots 822, 824, and 826, and FIG. 2C shows plots 828, 830, and 832, similar to plots 802, 804, and 806 of FIG. 2A.

In plot 822 of FIG. 2B, a curve 834 shows the input voltage to heater 710 and a curve 836 shows the power in waveguide 720. The pre-emphasis voltage comprises sharp peaks 838 with widths of 0.8 μs. In plot 824, a curve 840 shows a zero input voltage to heater 712, and a curve 842 shows the power in waveguide 722. The turn-on time of curve 842 is even faster than that of curve 816. In plot 826, curves 844 and 846 show the optical phase shifts under respective resistive heaters 710 and 712.

In plot 828 of FIG. 2C, a curve 848 shows the input voltage to heater 710 and a curve 850 shows the power in waveguide 720. The pre-emphasis voltage comprises sharp peaks 852 with widths of 1.0 μs. In plot 830, a curve 854 shows a zero input voltage to heater 712 and a curve 856 shows the power in waveguide 722. The turn-on time of curve 856 is similar to that of curve 842, but shows some distortion immediately after the power reaches its maximum. In plot 832, curves 858 and 860 show the phase shifts under respective resistive heaters 710 and 712.

FIG. 3A is a block diagram that schematically illustrates a thermo-optic switching tree on a PIC 900, in accordance with an embodiment of the invention. In this embodiment, pre-emphasis voltages are applied in sequence to both resistive heaters 710 and 712, on both branches 706 and 708 of Mach-Zehnder interferometer 704. In the pictured example, this sort of push-pull pre-emphasis scheme is applied only to the first tier of the switching tree, to enable fast switching between the upper and lower sub-trees in the network. Alternatively or additionally, switches in other, or all, tiers may be driven in this manner for fast switching.

PIC 900 comprises thermo-optic switches 902 similar to switches 702 in PIC 700 (FIG. 1A), with the addition of separate pre-emphasis voltage controllers 904 and 906 to a first-tier switch 903, as will be detailed hereinbelow. Switch 903 is similar to switch 703 (FIG. 1A). Items in switch 903 that are similar or identical to those in switch 703 are indicated by the same labels. Pre-emphasis voltage controllers 904 and 906, labeled PreEmp 1 and PreEmp 2, are shown as separate functional blocks for the sake of conceptual clarity. In practice, however, the pre-emphasis function may be integrated into digital controllers 724 and 726, representing a part of the voltage waveforms that are applied to resistive heaters 710 and 712. Monitoring photodiodes 908 and 910, labelled PMON, can be used to verify the current state of switch 903 and adjust the voltages if necessary for more precise switching.

FIG. 3B shows three plots 912, 914, and 916 illustrating schematically the response of switch 903 to the voltages applied by digital controllers 724 and 726, in accordance with an embodiment of the invention.

In plot 912, a curve 918 shows the input voltage to heater 710, where the input voltage is a sum of the basic switching voltage and the pre-emphasis voltage. The pre-emphasis voltage comprises peaks 920 located at the rising edges of the input voltage waveform. In this example, the width of each peak 920 is 0.8 μs. Curve 918 represents the optical output power from switch 903 into waveguide 720.

In plot 914, a curve 922 shows that only pre-emphasis voltage peaks 924 are applied to heater 712. Peaks 924 are located at the falling edges of the input voltage waveform to heater 710 (curve 918). The width of each peak 924 is 0.75 μs. In some embodiments, curve 922 may include a basic switching voltage.

In plot 916, curves 926 and 928 show respective optical phase shifts applied to branches 706 and 708 by heaters 710 and 712.

While driving heaters 710 and 712 with the respective voltages shown in plots 912 and 914, the temperatures of the two branch waveguides 706 and 708 increase continually in multiple cycles of alternating steps. Thus, the optical output of the switch toggles rapidly between outgoing waveguides 720 and 722 at each step. In other words, in the first step, the upper branch waveguide 706 (for example) is rapidly heated, with pre-emphasis voltage, by an increment ΔT, followed in the next step by rapid heating of the lower branch waveguide 708 by ΔT, followed by rapid heating of the upper branch waveguide 706 to 2ΔT, and so forth. The speed of switching is thus controlled by the fast heating time and is not limited by the slower cooling times of the heaters.

After a certain number of rapid switching cycles, the switch is allowed to cool off, after which the rapid switching operation can resume. Monitoring photodiodes (PMON) can be used, as shown in FIG. 3A, to verify the current state of the switch, or to aid in calibrating for variations in phase offset and voltage to phase-shift scale factor.

### Control of Thermo-Optic Switching

As discussed hereinabove, fast thermo-optic switch 703 is controlled by one or more digital controllers 724, 726, configured to set respective voltages applied to resistive heaters 710, 712 for heating branch waveguides 706 and 708 and thus controlling the respective optical phase shifts in optical signals propagating in the branch waveguides. The difference between the phase shifts is used to select outgoing waveguide 720 or 722 in accordance with a desired output or switching state of switch 703. For example, the switching state may be determined by the optical phase shift induced by temperature changes in the waveguides due to the driving voltages applied to respective resistive heaters 710 and 712. A first phase shift due to the driving voltages may result in switching the optical signal to outgoing waveguide 720, while a second phase shift due to a change in the driving voltages may result in switching the optical signal to outgoing waveguide 722, as shown in the example of FIG. 1B. Accordingly, the voltage waveforms applied to each resistive heater 710, 712 can determine the output state of switch 703 (whether a basic implementation or a pre-emphasis voltage implementation is utilized).

Controllers 724, 726 may be configured to select parameters of the driving voltages in order to obtain desired characteristics of the optical phase shifts in branch waveguides 706 and 708 and thus select the switching state of switch 703. For example, when implementing a push-pull scheme in which heaters 710 and 712 are driven in alternation to toggle the mixed optical signal between outputs of switch 703, the magnitude and the timing of the input voltages applied to a respective heater 710, 712 may affect the timing of a respective waveguide 720, 722 turning on (e.g., corresponding to a “turn-on time” or a “turn-off time” of switch 703) and the switching speed. For example, it may be desirable to apply a minimum driving voltage as quickly as possible so as to maximize the switching speed of toggling the switch output.

The input voltage for driving a respective heater 710, 712 may thus be controlled by feedback as a function of the output optical power 736, 738 of the respective output waveguides 720, 722, for determining the voltage waveform to be applied to toggle to the next switching state. However, controlling the driving voltages according to a direct measurement of waveguide output may lead to positive feedback and instability. In particular, measuring the output power of waveguides 720, 722 with a sensor, and then feeding the measured power back to the controllers 724, 726 for determining the form and timing of driving voltages to be applied to heaters 710, 712, could result in a positive feedback loop, as the output power is directly influenced by the driving voltages and the feedback polarity changes at optical power maximums and minimums. Thus, if there is even a small amount of overshoot beyond the optical power maximum (due to noise, for example), then the feedback polarity changes and an undesirable positive feedback loop occurs.

According to embodiments of the present invention, to overcome the problems associated with external feedback, the switch may be controlled internally using a digital model of the switch components. In one example, a mathematical model is used to model the behavior of at least one resistive heater and at least one waveguide of the switch, and the driving voltages applied to the heater may be controlled based on the model. In some embodiments, the model is analog and implemented with electronic components such as op-amps, capacitors and resistors.

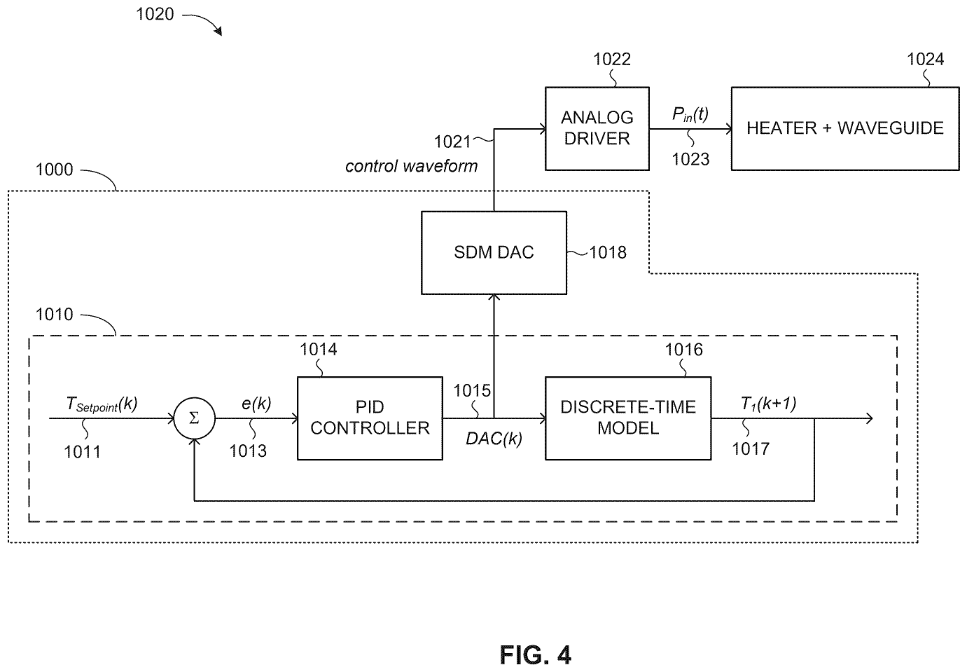

FIG. 4 is a block diagram that schematically illustrates an open-loop feedforward control system 1000 for controlling a thermo-optic switch 1020, in accordance with an embodiment of the invention. Control system 1000 includes a digital controller 1010 and a sigma-delta modulator (SDM) (also referred to as a delta-sigma modulator) based digital-to-analog converter (DAC) 1018. Digital controller 1010 includes a proportional-integral-derivative (PID) controller 1014 and a discrete-time numerical model 1016. In some embodiments, digital controller 1010 comprises a programmable processor, such as an embedded microcontroller, which is programmed in software or firmware to carry out the functions described herein. Additionally or alternatively, at least some of the functions of digital controller 1010 may be implemented in digital logic circuits, which may be hard-wired or programmable, such as a suitable application-specific integrated circuit (ASIC) or gate array.

Model 1016 is a mathematical representation of electro-thermal dynamics of a heater and waveguide (collectively referenced 1024), also referred to as a thermo-optic phase shifter (TOPS) 1024, of switch 1020. Model 1016 may be a discrete-time third-order numerical model, for example, although any other suitable type of digital model may be used. Model 1016 may represent a behavior or dynamics of the modeled heater and waveguide, such as a modeling of temperature characteristics in response to application of power, voltage, or current to the heater. In some embodiments the temperature characteristics include dynamics between an input current, voltage, or power to a model output of a waveguide temperature. In one example, model 1016 includes a discrete-time transfer function relating heater power to temperature. In general, model 1016 may include one or more numerical parameters and/or mathematical functions or operations applied in any sequence or combination, for representing the behavior of the modeled heater and waveguide 1024. Accordingly, model 1016 may be considered an “observer”, or a “replica” of heater and waveguide 1024, and this modeled heater and waveguide may be considered a “plant” of control system 1010. Model 1016 may include representations of multiple groups of heaters and waveguides, such as of a first resistive heater 710 and a first branch waveguide 706, and/or a second resistive heater 712 and a second branch waveguide 708 of switch 703 (FIG. 1A). Accordingly, model 1016 may include a plurality of individual models, such as for a respective heater and waveguide grouping, or alternatively a single model representing a plurality of heater and waveguide (TOPS) groupings. Model 1016 may be realized by one or more processors configured to execute processing instructions corresponding to the mathematical operation(s) defined in the discrete-time model. Alternatively or additionally, model 1016 may be realized by electronic circuitry configured to generate and/or update a numerical model representing the behavior or dynamics of the modeled heater and waveguide, and to output an electronic signal responsive to the numerical modelling, such as a signal reflective of a modeled waveguide temperature (as will be discussed hereinbelow).

PID controller 1014 is configured to regulate a variable using a feedback-control loop mechanism. A PID controller may modify a system parameter or “process variable (PV)” to approach a desired target value or “setpoint (SP)”. In particular, a PID controller may receive an error signal corresponding to a difference between the PV and SP, and apply a correction to the PV by applying: a proportional (P) output component, proportional to the magnitude of the error; an integral (I) output component, reflecting cumulative sum of past errors (to address residual steady-state errors); and a derivative (D) output component, reflecting rate of change of the error (to mitigate overshoot and enhance stability). Accordingly, PID controller 1014 of control system 1000 is configured to regulate a waveguide temperature of a modelled waveguide in accordance with a setpoint temperature (i.e., such that the waveguide temperature estimated by model 1016 represents the PV and the setpoint temperature represents the SP of control system 1010). PID controller 1014 may be represented as one or more numerical parameters and/or mathematical functions or operations applied in a sequence or combination, for applying the regulating or correction of a process variable. PID controller 1014 may be realized by one or more processors configured to execute processing instructions corresponding to the mathematical operation(s). Alternatively or additionally, PID controller 1014 may be realized by electronic circuitry configured to apply operations corresponding to the regulation or tracking of a waveguide temperature of a modelled waveguide in accordance with a setpoint temperature, and to output an electronic signal responsive to the regulation or tracking, such as a digital control signal for generating a driving voltage.

Sigma-delta modulator (SDM) DAC 1018 is configured to convert a multi-bit digital signal 1015 into a high-frequency single-bit digital output using sigma-delta modulation, giving rise to a control waveform 1021. An SDM DAC may utilize oversampling together with noise shaping and filtering to achieve a high-resolution output signal. In some embodiments the noise shaping is accomplished using a digital filter, and filtering is applied by the electrothermal dynamics of TOPS 1024. For example, an input digital signal may undergo initial modulation using a high-frequency pulse density modulation (PDM) at a much higher rate than the final analog signal, to reduce quantization error by spreading it across a wide frequency range, some of which is filtered, effectively improving signal accuracy and reducing noise. Accordingly, SDM DAC 1018 is configured to convert a digital output signal 1015 from PID controller 1014 to control waveform 1021, from which analog driver 1022 (which may comprise a switch) produces an analog output for generating a driving voltage or current for driving a heater of TOPS 1024. In one example, the DAC output is a one-bit value, and the analog output toggles between a first voltage and a second voltage based on the one-bit value. In another example, the DAC output is a one-bit value, and the analog output toggles between a first current and a second current based on the one-bit value. In one example, SDM DAC 1018 utilizes a zero-order hold, which is a linear time-invariant model of the signal reconstruction applied by the DAC. It is noted that sigma-delta modulation (SDM) is one example of a modulation technique utilized by a DAC, which may alternatively be embodied by other types of DACs using alternative and/or additional modulation techniques in other exemplary embodiments, such as: pulse-width modulation (PWM), pulse-code modulation (PCM), or a multi-bit digital to analog converter.

In operation of control system 1000, model 1016 outputs a computed value of a temperature 1017, T₁(k+1), reflective of an actual physical temperature of the modeled waveguide in heater and waveguide 1024. PID controller 1014 receives an input signal 1013, equal to an error value e(k) corresponding to a difference between model output 1017 and a desired waveguide setpoint temperature 1011, Tₛₑₜₚₒᵢₙₜ(k). The setpoint temperature 1011 may be predefined, for example determined empirically based on laboratory characterization or a calibration of heater and waveguide 1024, and may vary over time depending on the desired optical phase shift in the waveguide, for example as illustrated in the Figures. PID controller 1014 produces an output 1015, representing a digital control signal, DAC(k), to be fed into SDM DAC 1018 for generating a driving voltage to achieve a desired waveguide temperature (according to the control-loop feedback). SDM DAC 1018 receives digital control signal 1015, which may be a bitstream or binary sequence, from PID controller 1014 and produces control waveform 1021 as an output signal. Control waveform 1021 is fed into an analog driver 1022 of switch 1020, which generates, based on the control waveform 1021, a driving voltage 1023, Pᵢₙ(t), for applying to a heater of a thermo-optic switch (such as heaters 710, 712 shown in FIG. 1A). For example, the form and timing of driving voltages 1023 for driving one or more heaters 710, 712 of switch 703 may be determined by control waveform 1021 to achieve a desired waveguide output phase, and thus to obtain the desired output signal and/or switching state of switch 703.

Control system 1000 may operate dynamically to continually generate driving voltages for driving one or more heaters of the controlled switch, based on the modeled dynamics of the switch components defined in discrete-time model 1016. If the plant (i.e., the modeled heater and waveguide 1024) is accurately modeled by the observer (i.e., model 1016), then if an equal amount of modeled heat is applied to the observer as the physical heat that is applied the plant, it is expected that the temperature of the observer will match the temperature of the plant. Control system 1000 may be considered an open-loop feedforward control system in which the control action (i.e., control waveform 1021 determining a driving voltage of a heater) is independent of the controlled processed variable (i.e., waveguide temperature) and does not use feedback from the physical switch elements to compare with a desired waveguide setpoint temperature.

According to some embodiments, control system 1000 may generate a control waveform for driving a heater of a thermo-optic device including a single heater (which may be associated with a single waveguide), rather than a switch having two branches with resistive heaters on each branch (such as switch 703 shown in FIG. 1A).

The accuracy of model 1016 may be influenced by various dynamic and scale factor effects. Model 1016 may be dynamically updated, such as using an adaptation or calibration process. In one example, an adaptation process is applied periodically for a switch to verify and adjust the relation between the modeled temperature and the actual waveguide temperature during periods in which the switch is not being used to transfer laser radiation.

### Model Derivation

In one example, model 1016 is a discrete-time third-order model of heater and waveguide 1024 (FIG. 4). The model may include three time constants represented as τ₁, τ₂, τ₃ in the time domain. Application of a Laplacian transform of a triple exponential model with time constants τ₁, τ₂, τ₃ in the time domain provides a transfer function in the s-domain (complex-valued frequency domain), where a₁, a₂, a₃ represent the respective contributions of time constants τ₁, τ₂, τ₃ such that: a₁+a₂+a₃=1. As discussed hereinabove, model 1016 may be realized by electronic circuitry representing the thermal dynamics of the modeled heater and waveguide 1024 or by a processor programmed to model the thermal dynamics.

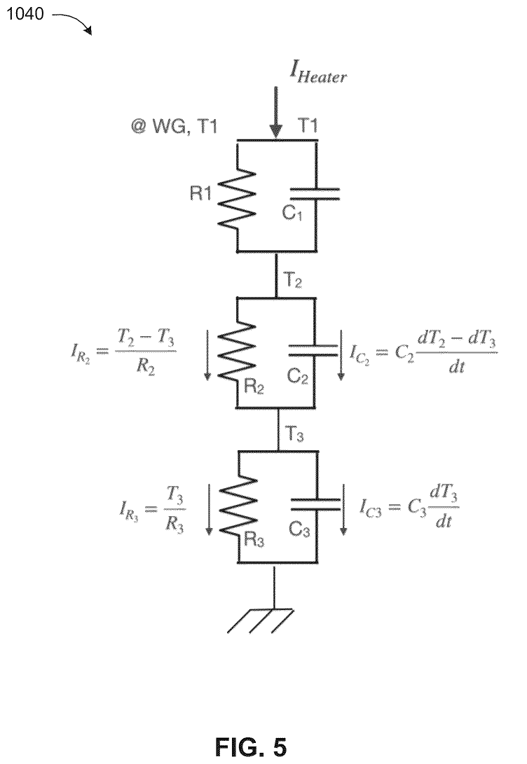

Reference is made to FIG. 5, which schematically illustrates an exemplary model, generally referenced 1040, for implementing a numerical modelling of a thermo-optic switch control system, in accordance with an embodiment of the invention. The rate of heat flow,

$$\frac{d {Q}_{h e a t e r}}{dt} ,$$

in model 1040 is considered a “heat current” and denoted as I_{Heater}. The modelled heat (Qₜ) is represented as charge (q), and the heat flow rate (qₜ) is represented as current (i). The modelled temperature (T) is represented as a voltage (V), and the modeled thermal resistance (Rₜ) and thermal capacitance (Cₜ) are represented as electrical capacitance (C) and electrical resistance (R), respectively.

Model 1040 is a third-order system, which includes three parallel resistor-capacitor (R-C) units connected in series. The temperature or voltage of a first node, T₁, of model 1040 may be represented by the following equation:

$${T}_{1} = [ \frac{{R}_{1}}{1 + {R}_{1} {C}_{1} s} + \frac{{R}_{2}}{1 + {R}_{2} {C}_{2} s} + \frac{{R}_{3}}{1 + {R}_{3} {C}_{3} s} ] {Q}_{heater} , where s = j w = j \cdot 2 \cdot π \cdot freq \qquad ( Eq . l )$$

A transfer function of model 1040 may be defined as follows:

$$H ( s ) = [ \frac{{α}_{1}}{1 + {τ}_{1} s} + \frac{{α}_{2}}{1 + {τ}_{2} s} + \frac{{α}_{3}}{1 + {τ}_{3} s} ] \qquad ( Eq . 2 )$$

Comparing Eq. 1 with the transfer function of Eq. 2, provides the following:

$${R}_{i} = \frac{{α}_{i}}{{P}_{π}} , and {C}_{i} = \frac{{τ}_{i}}{{R}_{i}} , for i = 1 , 2 , 3.$$

It is assumed that T₁ corresponds to the temperature for a π phase shift of a light wave propagating through the waveguide.

In some embodiments a continuous-time transfer-function model of the TOPS is converted to a discrete-time state-space model and this model is implemented using digital logic to realize an observer, for example model 1016.

In one example, when controlling a TOPS using model 1040, the temperature is raised to a setpoint T₁=1 (corresponding to π) using a high-energy pre-emphasis pulse, and the temperature is held at T₁=1 for a certain length of time. The dynamics for such a model may be described as follows.
1. In a first stage a pre-emphasis pulse (t<tₚₑ) is applied. During a fast pre-emphasis, the capacitances dominate the circuit behavior. The heat current is set at:

$${I}_{heater} = {P}_{p e} = \frac{{Q}_{p e}}{{t}_{p e}} , where {Q}_{p e} = \frac{1}{\frac{1}{{C}_{1}} + \frac{1}{{C}_{2}} + \frac{1}{{C}_{3}} 1} ;$$

and:

$$\frac{{dT}_{3}}{dt} = \frac{{I}_{h e a t e r}}{{C}_{3}} ; \\ \frac{{dT}_{2}}{dt} = {I}_{heater} ( \frac{1}{{C}_{2}} + \frac{1}{{C}_{3}} ) ; \\ \frac{{dT}_{1}}{dt} = {I}_{heater} ( \frac{1}{{C}_{1}} + \frac{1}{{C}_{2}} + \frac{1}{{C}_{3}} ) .$$

2. In a second stage, the temperature T₁ of the first node is held at the setpoint T_{d} following the pre-emphasis (tₚₑ<t<t_{off}):

$$Set \frac{{dT}_{1}}{dt} = 0 ; \\ \frac{{dT}_{2}}{dt} = \frac{1}{{C}_{1} {C}_{2} + {C}_{1} {C}_{3} + {C}_{2} {C}_{3}} ( \frac{( {C}_{2} + {C}_{3} ) ( {T}_{1} - {T}_{2} )}{{R}_{1}} - \frac{{C}_{3} ( {T}_{2} - {T}_{3} )}{{R}_{2}} - \frac{{C}_{2} {T}_{3}}{{R}_{3}} ) ; \\ \frac{{dT}_{3}}{dt} = \frac{1}{{C}_{1} {C}_{2} + {C}_{1} {C}_{3} + {C}_{2} {C}_{3}} ( \frac{{C}_{2} ( {T}_{1} - {T}_{2} )}{{R}_{1}} + \frac{{C}_{1} ( {T}_{2} - {T}_{3} )}{{R}_{2}} - \frac{( {C}_{1} + {C}_{2} ) {T}_{3}}{{R}_{3}} ) .$$

3. In a third stage, the heater is turned off (t>t_{off}):

$$Set {I}_{heater} = 0 ; \\ \frac{{dT}_{3}}{dt} = - \frac{{T}_{3}}{{R}_{3} {C}_{3}} ; \\ \frac{{dT}_{2}}{dt} = - \frac{{T}_{2} - {T}_{3}}{{R}_{2} {C}_{2}} - \frac{{T}_{3}}{{R}_{3} {C}_{3}} ; \\ \frac{{dT}_{1}}{dt} = - \frac{{T}_{1} - {T}_{2}}{{R}_{1} {C}_{1}} - \frac{{T}_{2} - {T}_{3}}{{R}_{2} {C}_{2}} - \frac{{T}_{3}}{{R}_{3} {C}_{3}} .$$

If the controlled thermo-optic switch 1020 includes two heaters, then the temperature of both heaters may be controlled to manipulate the MZI phase which is a differential phase described as follows:

$$Diff phase = {ϕ}_{1} - {ϕ}_{2} = \frac{2 π}{wave l e n g t h} \cdot \frac{dn}{dT} \cdot ( {T}_{heater 1} - {T}_{heater 2} ) \cdot {L}_{heater} .$$

The above equations may be expanded to include the dynamics of both heaters.

### Nonlinearity Compensation

Factors that may influence the operation of control system 1000 include nonlinearities exhibited by different elements. For example, the physical realizations of SDM DAC 1018 and/or analog driver 1022 may be characterized by at least one nonlinearity, which may not be reflected in model 1016 and may consequently result in divergence of the switch control from desired characteristics. Another example is nonlinearity exhibited by the modeled heater, which may arise due to the temperature coefficient of the heater resistor. As the heater is energized, the temperature of the resistive layer generally rises, which causes an increase in the resistance over time. These nonlinearities may introduce errors in the controlled switch.

According to embodiments of the present invention, physical nonlinearities associated with the TOSW control system may be compensated for using one or more nonlinearity compensation approaches. In one example, a nonlinearity compensation approach includes accounting for the physical nonlinearities in the discrete-time numerical model of the control system. In another example, a nonlinearity compensation approach involves adding an inverse nonlinearity between the controller output and the SDM-DAC input of the control system. Either or both of these two approaches may be used.

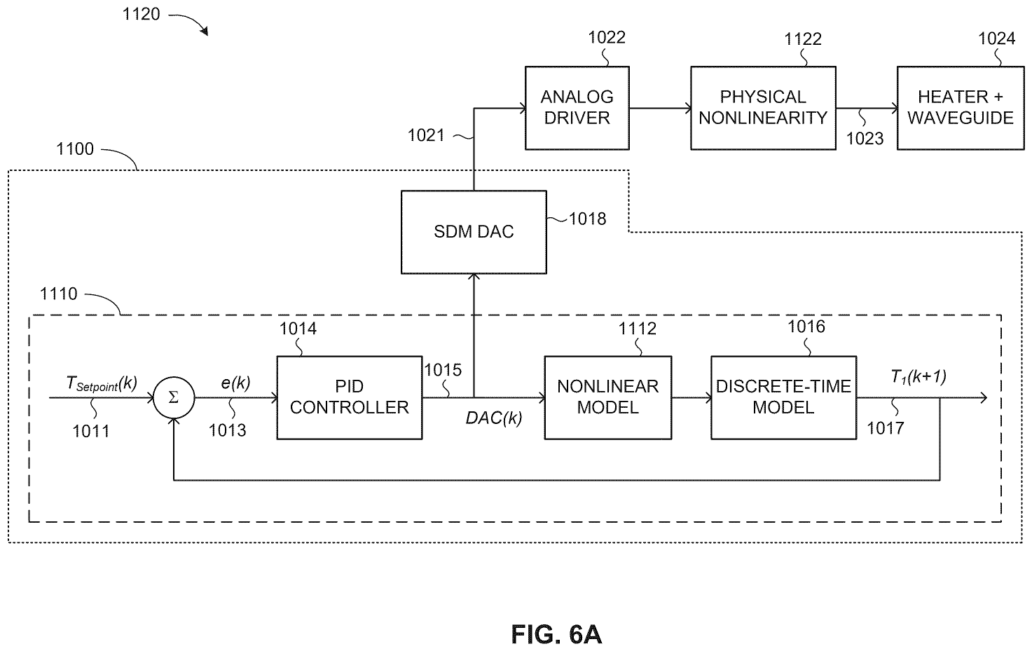

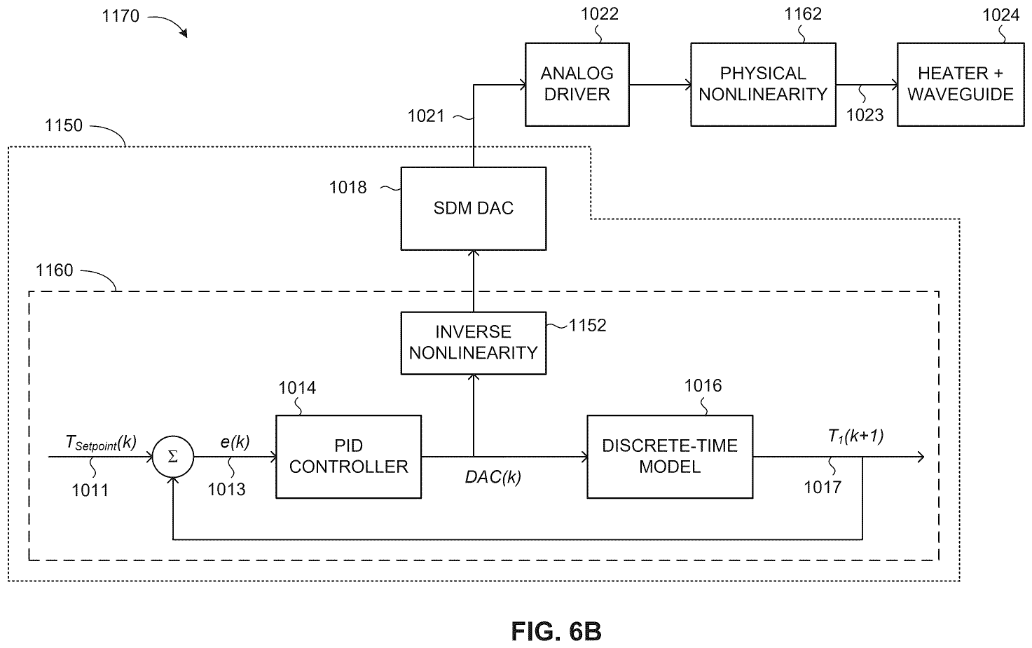

Reference is made to FIGS. 6A and 6B, which schematically illustrate exemplary nonlinearity compensation approaches for respective TOSW control systems. The same indicator numbers are used in these figures as in FIG. 5 to denote similar elements, although the performance of these elements may differ as a result of the nonlinearity compensation. In the example of FIG. 6A, a control system 1100 for controlling a TOPS of a switch 1120 is generally analogous to control system 1000 shown in FIG. 4, with the addition of a nonlinearity modelling (represented as block 1112) for modelling a physical nonlinearity (represented as block 1122) of analog driver 1022 and/or heater and waveguide (TOPS) 1024. Nonlinearity (NL) modelling block 1112 of digital controller 1110 of control system 1100 may be a numerical model that may be integrated with and/or utilized by discrete-time model 1016. NL modelling block 1112 may include one or more numerical parameters and/or mathematical functions or operations applied in any sequence or combination, for representing a physical nonlinearity associated with control system 1100 or TOPS 1024, such as a physical nonlinearity of driver 1022 and/or TOPS 1024. In one example, parameters of NL modelling block 1112 include an offset, a linear term, and an exponential term, which operate on the current digital waveform value DAC (k). In another embodiment the NL modelling block 1112 includes a polynomial function. The coefficients of these terms may be computed by measuring a physical response of nonlinearity block 1122 as a function of input voltage and temperature. For example, NL modelling block 1112 may compute a second-order dominant nonlinearity present in driver 1022, causing the feedback loop to generate a corresponding digital correction, which will modify the value DAC(k) of digital control signal 1015 that is input to DAC 1018.

In the example of FIG. 6B, a control system 1150 for controlling a TOPS of a thermo-optic switch 1170 is generally analogous to control system 1010 shown in FIG. 4, with the addition of an inverse nonlinearity 1152 to cancel a physical nonlinearity (represented as block 1162) of analog driver 1022 and/or SDM DAC 1018. Inverse nonlinearity (INL) block 1152 of digital controller 1160 of control system 1150 may include one or more numerical parameters and/or mathematical functions or operations applied in any sequence or combination, for representing an inverse of a physical nonlinearity associated with control system 1150, such as a physical nonlinearity of driver 1022. The use of an inverse nonlinearity block 1152 in control system 1150 may provide a similar effect to the use of NL modelling block 1112 in control system 1100. In one example, INL block 1152 is a second-order inverse nonlinearity, which is represented by the equation: y=a+b*x+c*x², with coefficients calibrated to compensate for physical nonlinearity block 1162.

As yet another alternative (not shown in the figures), control system 1150 may compensate for nonlinearity by adjusting the waveguide setpoint temperature, T_{Setpoint}(k), such that the setpoint temperature would be different when modelling a second-order inverse nonlinearity.

The performance of the nonlinearity compensation approaches may be similar, and is dependent on the accuracy of the respective NL modelling or inverse nonlinearity. When utilizing an INL-based compensation, the loop gain of model 1016 may be constant and linear, as long as the effect of the nonlinearity on loop gain is sufficiently small for reasonable nonlinearity levels.

In some embodiments the nonlinearity model includes a saturation nonlinearity before the digital control signal is output. The saturation nonlinearity models the finite range of the DAC. Thus, when the digital control signal reaches a value that is higher or lower than the DAC digital input supports, the saturation nonlinearity clips the digital control signal thereby causing the observer model to track the actual plant which is being driven by a saturated DAC. In this way a pre-emphasis pulse may be readily generated; pre-emphasis pulse in this instance is simply the controller saturating. The saturation nonlinearity may be applied within the digital controller (e.g., controller 1110 or 1160 of FIGS. 6A of 6B), or at the output of the digital controller (e.g., prior to DAC 1018 of FIG. 6A).

Although the description above relates to modeling and control of a single TOPS, the principles of these embodiments can typically be applied in pairs of TOPS used in a thermo-optic switch, as noted earlier, such as in switches 703 and 903, shown respectively in FIGS. 1A and 3A. In these switches, the two heaters 710 and 712 can be driven in concert so that one heater cools while the other one is driven.

For example, given a first waveguide and a second waveguide, the first waveguide being at such a temperature higher than the second waveguide that the switch outputs light to a first output port, then the output may be rapidly switched to a second output port by rapidly heating the second waveguide to a temperature higher than the first waveguide, the difference between the first and second waveguide temperatures (and hence phases) being sufficient to change the output port. Immediately upon switching, the first waveguide is allowed to cool by removing power from the first heater, and the desired differential phase is attained by controlling the second heater setpoint to track a constant temperature (i.e., phase) difference above the cooling waveguide temperature. In this way, the second-heater setpoint is controlled to maintain the desired phase shift as the other heater cools. Thus, a phase shift of π between the corresponding waveguides may be rapidly applied and thereby toggle the switch.

Furthermore, although the description above emphasizes the 1×2 switching configurations of switches 703 and 903, the principles pf the present invention can similarly be applied in thermo-optic switches of higher radix. For example, in a 1×4 switch, four heaters can be driven in concert to switch the input beam among four output ports. It can be advantageous, in terms of temperature control and efficiency, to disable the coolest heater in each switching time slot and to control the setpoints of the other heaters to maintain the desired phase shifts relative to the coolest heater.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A thermo-optic device, comprising:
a waveguide having a respective input end and output end;
a heater, configured to heat the waveguide;
a digital controller, configured to generate a digital control signal selected to induce a target phase shift in an optical signal propagating through the waveguide; and
a digital-to-analog converter (DAC) coupled to convert the digital control signal to an analog signal for application to the heater.

2. The device according to claim 1, wherein the digital controller is configured to update a numerical discrete-time model of the heater and the waveguide, and to generate the digital control signal responsive to the model.

3. The device according to claim 2, wherein the numerical discrete-time model is configured to compute a model temperature of the waveguide, and wherein the digital controller is configured to generate the digital control signal responsively to a difference between a setpoint temperature corresponding to the target phase shift and the model temperature.

4. The device according to claim 3, wherein the digital controller comprises a proportional-integral-derivative (PID) controller, which is configured to receive the difference between the setpoint temperature and the model temperature as an input and to output the digital control signal.

5. The device according to claim 4, wherein the digital controller is configured to drive the heater with a voltage, corresponding to the analog waveform, the voltage including a pre-emphasis pulse.

6. The device according to claim 2, wherein the digital controller is configured to update the numerical discrete-time model using a calibration process.

7. The device according to claim 2, wherein the numerical discrete-time model comprises a nonlinear modelling of at least one physical nonlinearity of a portion of the device.

8. The device according to claim 1, wherein the DAC comprises at least one component selected from the group of components consisting of: a delta-sigma modulator; a sigma-delta modulator; a switch; and an amplifier.

9. The device according to claim 1, wherein the digital controller is configured to apply an inverse nonlinearity of at least one physical nonlinearity of a portion of the device, to the digital control signal.

10. The device according to claim 3, wherein the digital controller is configured to apply a saturation nonlinearity before the digital control signal is generated, the saturation nonlinearity modeling a finite range of the DAC.

11. A thermo-optic switch, comprising:
an interferometer comprising first and second waveguides having respective input ends and output ends;
at least one heater configured to heat at least one of the first and second waveguides;
a splitter coupled to receive a coherent optical signal and to input the optical signal to the input ends of both the first and second waveguides;
a mixer coupled to receive and mix the optical signal from the output ends of the first and second waveguides and to direct the mixed optical signal to a first output or a second output of the switch depending on a phase shift between the first and second waveguides;
a digital controller, configured to generate at least one digital control signal selected to induce a target phase shift in the optical signal propagating through the at least one of the first and second waveguides; and
at least one digital-to-analog converter (DAC) coupled to convert the at least one digital control signal to at least one analog waveform for application to the at least one heater.

12. The switch according to claim 11, wherein the at least one heater comprises first and second heaters coupled respectively to heat the first and second waveguides, wherein the digital controller is configured to generate first and second digital control signals, and wherein the at least one DAC comprises first and second DACs coupled to convert the first and second digital control signals to first and second analog waveforms for application to the first and second heaters, respectively.

13. The switch according to claim 12, wherein the digital controller is configured to drive the first heater and the second heater in alternation, to toggle the mixed optical signal between the first output and the second output of the switch.

14. The switch according to claim 13, wherein the digital controller is configured to drive the first heater and the second heater with a voltage, corresponding to the analog waveform, the voltage including a pre-emphasis pulse when the mixed optical signal is toggled.

15. The switch according to claim 11, wherein the digital controller is configured to update a numerical discrete-time model of the at least one heater and at least one of the first and second waveguides, and to generate the digital control signal responsive to the model.

16. The switch according to claim 15, wherein the numerical discrete-time model is configured to compute a model temperature of the waveguide, and wherein the digital controller is configured to generate the digital control signal responsively to a difference between a setpoint temperature corresponding to the target phase shift and the model temperature.

17. The switch according to claim 16, wherein the digital controller comprises a proportional-integral-derivative (PID) controller, which is configured to receive the difference between the setpoint temperature and the model temperature as an input and to output the digital control signal.

18. The switch according to claim 15, wherein the digital controller is configured to update the numerical discrete-time model using a calibration process.

19. The switch according to claim 15, wherein the numerical discrete-time model comprises a nonlinear modelling of at least one physical nonlinearity of a portion of the device.

20. The switch according to claim 11, wherein the digital controller is configured to apply an inverse nonlinearity of at least one physical nonlinearity of a portion of the device, to the digital control signal.

21. The switch according to claim 16, wherein the digital controller is configured to apply a saturation nonlinearity before the digital control signal is generated, the saturation nonlinearity modeling a finite range of the DAC.

22. The switch according to claim 11, wherein the DAC comprises at least one component selected from the group of components consisting of: a delta-sigma modulator; a sigma-delta modulator; a switch; and an amplifier.

23. A method for thermo-optic switching, comprising:
generating, by a digital controller, a digital control signal selected to induce a target phase difference between a first waveguide and a second waveguide of a thermo-optic switch; and
converting, by a digital-to-analog converter (DAC), the digital control signal to at least one analog waveform for application to at least one heater in the thermo-optic switch, for heating at least one of the first waveguide and the second waveguide,
such that an optical signal from the output ends of the first waveguide and the second waveguide is switched between a first output or a second output of the switch, depending on the target phase difference.

24. The method according to claim 23, wherein generating the digital control signal comprises generating first and second digital control signals corresponding to first and second analog waveforms for application to heat the first waveguide and the second waveguide in alternation, to toggle the optical signal between the first output and the second output of the switch.

25. The method according to claim 24, wherein generating the digital control signal comprises applying a pre-emphasis pulse to drive the heater.

26. The method according to claim 23, wherein generating the digital control signal comprises updating a numerical discrete-time model of the heater and the waveguide, and generating the digital control signal responsive to the model.

27. The method according to claim 26, wherein generating the digital control signal comprises computing, by the numerical discrete-time model, a model temperature of the waveguide, and generating the digital control signal responsively to a difference between a setpoint temperature corresponding to the target phase shift and the model temperature.

28. The method according to claim 27, wherein generating the digital control signal comprises receiving, by a proportional-integral-derivative (PID) controller of the digital controller, the difference between the setpoint temperature and the model temperature as an input, and outputting the digital control signal by the PID controller.

29. The method according to claim 26, further comprising updating the numerical discrete-time model using a calibration process.

30. The method according to claim 26, further comprising a nonlinear modelling of at least one physical nonlinearity of a portion of the device.

31. The method according to claim 23, comprising applying an inverse nonlinearity of at least one physical nonlinearity of a portion of the device, to the digital control signal.

32. The method according to claim 26, comprising applying a saturation nonlinearity of the DAC, before generating the digital control signal.

33. A method for controlling a thermo-optic device, comprising:
generating, by a digital controller, a digital control signal selected to induce a target phase shift in an optical signal propagating through a waveguide by heating the waveguide; and
converting, by a digital-to-analog converter (DAC), the digital control signal to an analog waveform for application to a heater of the waveguide.

34. The method according to claim 33, wherein generating the digital control signal comprises generating and updating a numerical discrete-time model of the heater and the waveguide, and generating the digital control signal responsive to the model.

35. The method according to claim 34, wherein generating the digital control signal comprises computing, by the numerical discrete-time model, a model temperature of the waveguide, and generating the digital control signal responsively to a difference between a setpoint temperature corresponding to the target phase shift and the model temperature.

36. The method according to claim 35, wherein generating the digital control signal comprises receiving, by a proportional-integral-derivative (PID) controller of the digital controller, the difference between the setpoint temperature and the model temperature as an input, and outputting the digital control signal by the PID controller.

37. The method according to claim 33, comprising driving the heater with a voltage including a pre-emphasis pulse, the voltage corresponding to the analog waveform.

38. The method according to claim 34, comprising updating the numerical discrete-time model using a calibration process.

39. The method according to claim 32, comprising a nonlinear modelling of at least one physical nonlinearity of a portion of the device.

40. The method according to claim 31, comprising applying an inverse nonlinearity of at least one physical nonlinearity of a portion of the device, to the digital control signal.

41. The method according to claim 34, comprising applying a saturation nonlinearity of the DAC, before generating the digital control signal.
